(19) United States
(12) Patent Application Publication
(10) Pub. No.: US 2007/0273179 A1
(43) Pub. Date: Nov. 29, 2007

(54) Joining Area for Attaching an Add-On Piece to a Vehicle Body

(75) Inventors: Christoph Hommel, Stuttgart (DE); Joachim Winckler, Calw (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DAIMLERCHRYSLER AG, STUTTGART (DE)

(21) Appl. No.: 10/588,632

(22) PCT Filed: Feb. 1, 2005
(86) PCT No.: PCT/EP05/00957

§ 371 Date: Apr. 30, 2007

(30) Foreign Application Priority Data
Feb. 5, 2004 (DE) 10 2004 005 571.8

(51) Int. Cl. B62D 27/06

(52) U.S. Cl. 296/204

(57) ABSTRACT

A connection region (1) on a vehicle body (14), in the region of which an add-on part (17) is attached to the vehicle body (14) is provided. The connection region includes a connecting element (10) having a receiving region (18) for detachably fastening the add-on part (17). The connection region has a first and second fastening section (3, 5) at which the connecting element is connected to the vehicle body (14). In the first fastening section (3) the connecting element (10) is attached to a carrier component (4) of the vehicle body (14) by resistance pressure welding. In the second fastening section (5), which is arranged opposite the first fastening section (3) at a distance therefrom, the connecting element (10) can be connected to a stiffening panel (6) of the vehicle body (14). Such a connection region is used in particular for attaching an axle bolster (17) to a floor region (15) of the body (14).

The invention relates to a connection region on a vehicle body for attaching an add-on part to the vehicle body, in particular for attaching an axle bolster to a vehicle floor.

It is known for motor vehicle bodies of unitary construction to be stiffened in certain body regions, for example axle attachment regions, using additional stiffening elements without an appreciable increase in weight. It is conventional to provide body-mounted centering pins which serve for aligning and fastening the add-on part. These centering pins are connected to the body by means of conventional welding methods, such as shielded arc welding, for example. The use of such welding methods is associated with the problem of the corrosion protection being lost in the joining regions, which means that complicated additional measures must be employed to protect these regions against corrosion. Furthermore, quality monitoring of the fastening points is difficult, since it requires separation of the body parts at the connection point and is thus not nondestructive. Moreover, labor-intensive finishing work is required for conventional welded joints produced by means of shielded arc welding at the contact faces.

By contrast with this, the object of the invention is to provide a connection region for attaching an add-on part, in particular an axle bolster, to a vehicle body, in which positionally accurate and secure fastening of the add-on part is ensured without weak points occurring locally with regard to corrosion and to connection points which cannot be monitored between the vehicle body and the stiffening elements.

This object is achieved by a connection region according to the features of claim 1 and by a vehicle body as claimed in claim 7. Advantageous embodiments and developments form the subject matter of the dependent claims.

The body-side connection region according to the present invention comprises a connecting element which is provided with a receiving region for attaching the add-on part. The connecting element further comprises a first fastening section for welding to one or more carrier components of the vehicle body and a second fastening section for connecting to a stiffening panel of the vehicle body. The first fastening section is designed for resistance pressure welding and has a corresponding surface coating; the second fastening section is at a distance from the first fastening section and is connected to the stiffening panel, thereby achieving torque support between the first and second fastening sections. On the one hand, the connection region according to the invention therefore offers (owing to the resistance pressure welding between the carrier component and connecting element) the possibility of producing a welded joint with a carrier component without damaging the corrosion protection at the connection region. On the other hand, it is possible to achieve improved rigidity in the fastening of an add-on part to any desired carrier component of a vehicle body: the spaced-apart, second fastening section allows a type of torque support to be achieved between the carrier component and stiffening panel. The secure fastening is ensured hereby not only at one point of the stiffening element, instead, a type of two-point fastening via, on the one hand, resistance pressure welding on the vehicle body side and, on the other hand, a detachable or nondetachable second, spaced-apart fastening with the stiffening element ensures the highest possible efficiency in terms of stiffening. The connection region according to the invention has increased torsional and deformation rigidity, without the fastening section on the connecting element having to be laboriously finished or leading to problems in terms of corrosion resistance of the panel sections. The body-side fastening by means of resistance pressure welding results in no damage being caused to the overall corrosion protection at the mounting points. To this end, the connecting element is advantageously provided with a surface coating which is compatible with joining techniques, and can additionally be sealed with a PVC layer, for example.

The connection region according to the invention ensures that, when joining the connecting element, a high degree of repeatability is achieved, as is required particularly for fully automated large series production. The joining method of resistance pressure welding according to the invention achieves a high degree of reproducibility and dimensional accuracy combined with only small position or production tolerances. The connecting elements serve equally as positioning aids even before they are welded. The fastening points between the connecting element and the stiffening element or the carrier component can also be quality-monitored in a nondestructive manner. This may be performed, for example, via an ultrasound monitoring method by contrast with conventional shielded arc welded joints between the panel parts to be connected, in which nondestructive testing is not possible. The connection region according to the invention also has the advantage that even relatively thick metal panels and a large number of panels (as carrier component) lying one against the other in layers do not present any problem in terms of a connection with the connecting element and the stiffening element to be fastened thereon. Resistance pressure welding is thus extremely effective and can be used in a large number of applications of such stiffening regions on vehicle bodies.

According to an advantageous embodiment of the invention, the connecting element has the form of a stud, and the second fastening section of the connecting element is formed as a threaded section which is situated at that end of the connecting element opposite the first fastening section. After welding the first fastening section using a resistance pressure welding method, the second fastening section of the connecting element can be connected to the stiffening element via a detachable screwed connection. Moreover, assembly by means of a screwed connection can be carried out quickly, and it is also possible to produce a predetermined tightening torque in the stiffening element by means of the screwed connection. This ensures a secure and detachable connection between the stiffening element and the carrier component with the aid of the connecting element.

The connecting element advantageously has an elongate central region between the first and second fastening sections. Accordingly, the torque support by means of the connecting element can be increased by correspondingly increasing the intermediate section between the two joining or connecting planes. The rigidity of the connection is thus improved.

According to a further advantageous embodiment of the invention, the fastening sections of the connecting element have diameters which are respectively adapted to fastening and positioning openings of the stiffening element and/or of the vehicle body. The connecting element thus allows exact body-side positioning of the stiffening panel even before it is fixedly connected to the carrier component. The attachment of peripheral components is simplified as a result. The configuration according to the invention of the connection region thus makes it possible for stiffening systems (for example in an axle attachment region of the vehicle) to be produced with a high degree of repeatability and dimensional accuracy. In addition, accurate prepositioning by means of the connecting element of adapted diameter is not influenced by the subsequent welding operation by means of resistance pressure welding. The invention therefore renders additional positioning pins, as were required in the prior art, superfluous. The connecting element which serves for fastening at the same time assumes a positioning and aligning function. According to an advantageous embodiment in this regard, the first fastening section has a positioning element by means of which the connecting element is positioned highly accurately in a mounting opening of the carrier component prior to the welding operation. The positioning element is, for example, a protruding, cylindrical stud section having a dimension and length adapted to the mounting opening.

According to a further advantageous embodiment of the invention, a centering bore for a joining or screwing tool is provided in the second fastening section of the connecting element. The centering bore makes it easier to place a joining tool and, in particular, a screwing tool in the case of a screwed connection at the second fastening section. This makes it easier to mount the connecting element. Additional mounting jigs or specifically adapted mounting tools are not required.

According to a further advantageous embodiment of the invention, the welding section of the connecting element is a flangelike lug whose underside is provided with a peripheral welding projection or projection segments for resistance pressure welding. Joining by means of resistance pressure welding is thus extremely reliable and allows a long-term, fixed connection between parts without damaging the corrosion protection on the lateral edges of a mounting opening of body parts.

The unitary-construction vehicle body according to the invention as claimed in claim 7 has a floor region on which are provided a plurality of connection regions at which an add-on part is fastened. Each of the connection regions has—as described above—a connecting element which is provided with a first and second fastening section and which is connected in these regions to the floor or to a stiffening panel. The connection with the floor is carried out by means of resistance pressure welding, which ensures that there is no local loss of corrosion protection at the edge of a mounting opening in the body part. The welded joint is situated slightly to the outside of the respective mounting opening in the form of a preferably protruding, annular bead, so that the fusion of the metal due to the welding operation occurs in a region of the stud that is not accessible from outside. Subsequent finishing of the connection point is not required. The second fastening section of the connecting element provides additional torque support within the stiffening element, with the result that the connecting element constitutes a type of support stud.

Further advantages and features of the invention can be taken from the description given below, in which the invention is described with reference to the exemplary embodiment represented in the appended drawings.

In the drawings:

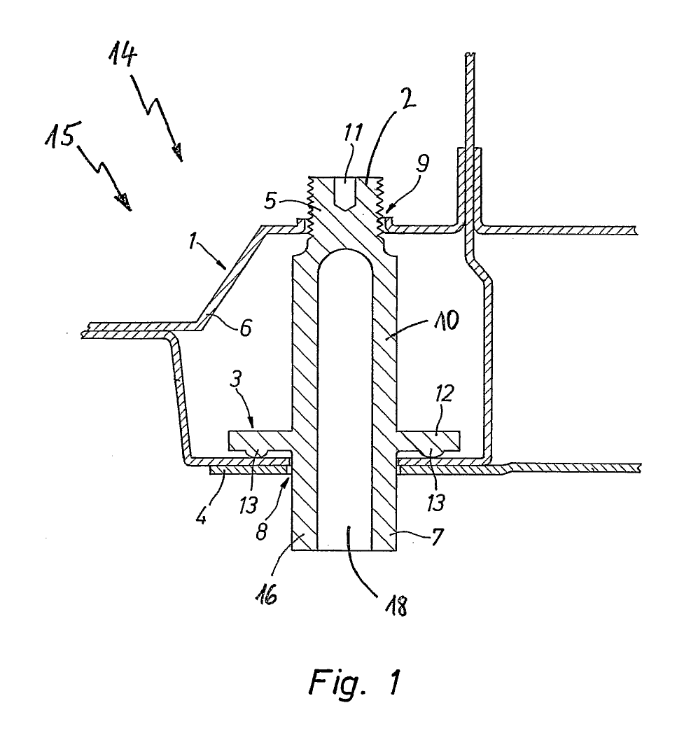

FIG. 1 shows a sectional view of an exemplary embodiment of a connection region according to the invention;

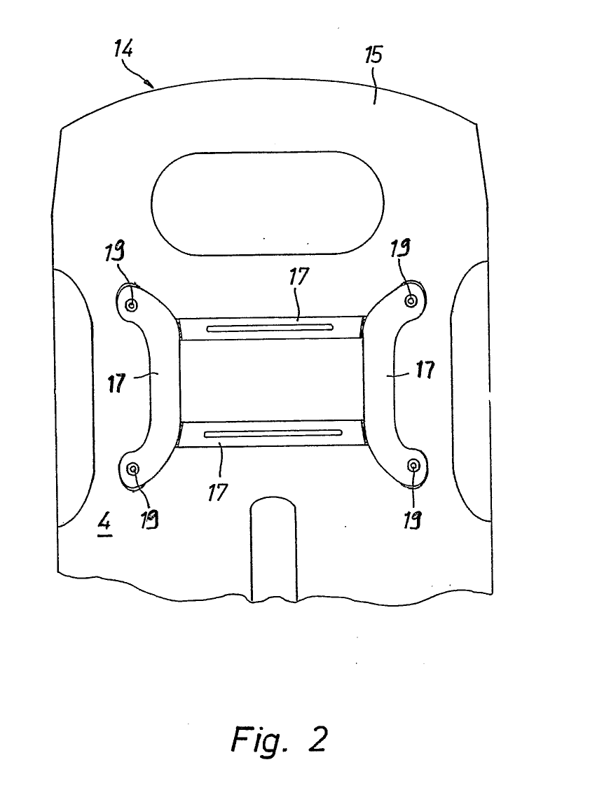

FIG. 2 shows a plan view from below of an arrangement according to the invention of an add-on part on a floor of a vehicle body comprising four fastening and mounting studs according to the invention.

FIG. 1 shows a detail of a vehicle body 14—in the present example of a floor region 15 of a unitary-construction vehicle body—comprising a connection region 1 according to the present invention in a mounting arrangement. The connection region 1 comprises regions of a carrier component 4, of a stiffening panel 6 and also a connecting element 10, which is a substantially cylindrical stud. The stiffening panel 6 is connected fixedly to the carrier component 4 in order to reinforce and stiffen locally defined regions of the floor 15—in particular the attachment points of an axle bolster 17.

The connecting element 10 has a first fastening section 3 in whose region the connecting element 10 is connected to the carrier component 4 by means of resistance pressure welding. As can be seen from FIG. 1, the first fastening section 3 has the form of an annular flange 12 provided with welding projections 13 which protrude from its underside. During the resistance pressure welding operation, the welding projections 13 are fused to the side of the carrier component 4 situated opposite the flange 12, resulting in a fixed connection between the connecting element 10 and the floor 15 of the vehicle body. This type of welded joint makes it possible to avoid surface damage being caused to the corrosion protection at the mounting opening 8 or the connection region of the floor panel 15. By contrast with conventional methods in which shielded arc welding is used to connect a stud or the stiffening element directly to the vehicle body panel, it is thus possible for the stiffening elements to be fastened in such a way that there is no need for finishing work or subsequent reapplication of the corrosion protection.

A second fastening section 5 is provided at the opposite end of the connecting element 10 and at a distance from the first fastening section 3. This second fastening section 5 is formed, for example, by an external thread on a cylindrical section of the connecting element 10, on which a nut (not shown in FIG. 1) can be screwed in order to clamp the connecting element 10 with respect to the stiffening panel 6. Alternatively, or in addition, the connecting element 10 can have the second fastening section 5 welded to the stiffening panel 6. This results in torque support of the connecting element 10—and thus of the add-on part 17 attached at a receiving region 18 of the connecting element 10—being achieved at the stiffening panel 6.

The connecting element 10 has, in the region of its upper and its lower end, cylindrical sections 2, 16 whose diameters are adapted to the diameters of mounting openings 8, 9 in the carrier component 4 and in the stiffening panel 6. This ensures secure positioning prior to final fixing of the connecting element 10. This centering is achieved in the vicinity of the first fastening section 3 by means of a sleeve-shaped positioning element 7 which engages through a circular opening 8 in the carrier panel. The add-on part 17 can thus be mounted and fastened on the carrier component 4 without inaccuracies occurring in the position of these parts. Dimensional accuracy and repeatability for series production is consequently ensured.

In this exemplary embodiment, the connecting element 10 has a further centering bore 11 which serves for the placement of a joining tool, such as, for example, a screwing drill for a nut to be screwed on, or a welding robot.

FIG. 2 is a part view from below showing a floor region 15 of a vehicle body 14. An axle bolster 17 is connected to the carrier component 4 by means of bolts 19 which are screwed into the receiving regions 18 of the connecting elements 10. The fact that the second fastening section 5 of the connecting element 10 is supported on the stiffening panel 6 ensures a reinforced and stiffened attachment of the axle bolster 17 to the vehicle body 14. In this exemplary embodiment, there are provided four fastening bolts 19 for fastening the axle bolster 17 to the body, these bolts cooperating with four body-side connection regions 1.

All the features and elements presented in the description, the claims which follow and the drawing may be essential to the invention both individually and in any desired combination with one another.

1-7. (canceled)

8. A connection region on a vehicle body for attaching an add-on part to the vehicle body, the connection region comprising:
a connecting element having a receiving region for detachably fastening the add-on part, and having first and second fastening sections for attaching the connecting element to the vehicle body, the first fastening section being designed for resistance pressure welding to a carrier component of the vehicle body, and the second fastening section being arranged at a distance from the first fastening section, the connecting element in a region of the second fastening section being connectable to a stiffening panel of the vehicle body.

9. The connection region as recited in claim 8 wherein connection region id a floor region of the vehicle body and the add-on part is an axle bolster.

10. The connection region as recited in claim 8 wherein the second fastening section of the connecting element is a threaded section.

11. The connection region as recited in claim 8 wherein the connecting element has, in the region of the first fastening section, a positioning element for positionally accurate positioning of the connecting element in a mounting opening of the carrier component.

12. The connection region as recited in claim 8 wherein the connecting element has, at the first and second fastening sections, diameters respectively adapted to fastening and positioning openings of the carrier component and of the stiffening panel.

13. The connection region as recited in claim 8 wherein the region of the second fastening section of the connecting element has a centering bore for a joining or screwing tool

14. The connection region as recited in claim 8 wherein the first fastening section has a flangelike lug having a peripheral welding projection.

15. A vehicle body of unitary construction with a floor region, the vehicle body comprising a plurality of connection regions as recited in claim 1 for attaching the add-on part.
